(19) United States
(12) Patent Application Publication
(10) Pub. No.: US 2019/0337165 A1
(43) Pub. Date: Nov. 7, 2019

(54) SEALED JOINT MODULE AND ARM USING SAME

(71) Applicant: ENGINEERING SERVICES INC., MARKHAM (CA)

(72) Inventors: XIAOJIA HE, TORONTO (CA); ZIREN LU, THORNHILL (CA); ANDREW A. GOLDENBERG, TORONTO (CA)

(21) Appl. No.: 15/969,141

(22) Filed: May 2, 2018

(51) Int. Cl. B25J 17/00; B25J 19/00

(52) U.S. Cl. CPC B25J 17/00; F16J 15/32; B25J 19/0075

(57) ABSTRACT

A sealed joint module is for use in association with an arm element of a robotic arm. The arm element may be a link, a seat, a payload interface or the like. The sealed joint module includes a module housing, a hollow joint assembly and a sealing assembly. The hollow joint assembly is operably attached to the module housing. The arm element is operably attachable to the hollow joint assembly. The sealing assembly is operably attached to the joint and to the module housing. The sealing assembly includes a dynamic sealing component between the arm element and the actuator assembly. A modular robot arm includes at least two sealed joint modules and at least one link.

### FIELD OF THE DISCLOSURE

This disclosure relates to sealing robotic joints and robotic arms using the joints and in particular a two-joint module having two degrees of freedom and having a generally L-shape and robotic arms using same.

### BACKGROUND

Robotic joints and robotic arms are used in a wide variety of environments. In certain environments such as painting, coating and spraying applications, robotic arms operate in hazardous working environment. The electrical components, such as motors inside the arm body need protection from moist, sparks, flammable gases, etc. The robot arm should prevent external hazardous matters from leaking into the arm.

Several different solutions have been proposed for robotic arms for use in hazardous environments. One example is U.S. Pat. No. 7,878,088 patent issued to Tamura et al. which discloses a sealing device for a joint section of a robotic arm. According to Tamura, the arm is non-modular and therefore actuators are not integrated as an assembly and a lot of bearing layers/mechanical parts are used to transmit rotational forces. Consequently lots of gaps/seams exist between mechanical parts. The sealing devices suggested by Tamura are installed in the gaps between mechanical parts. However, this sealing is not fully reliable, very complicated and would be difficult to install, maintain or replace.

Another prior art patent is U.S. Pat. No. 6,835,248 issued to Haas et al. which discloses a sealing method for painting robots. An industrial robot disclosed in the Hass patent has a plurality of relatively movable housing enclosures to protect electronics components, such as motors. The housing enclosure has a gas inlet and outlet. A source of non-combustible gas under pressure is connected to each motor housing inlet to circulate non-combustible gas through the motor housing and to direct the gas into the robot housing enclosures. Therefore, the motor housing always has a positive air-pressure from inside against the outside to prevent external gas leaking into the housing. However, there is a limitation for this method. There are multiple motors inside the robot and to protect all of the motors, multiple housing enclosures have to be installed. In addition, to inject non-combustible gas into the housing enclosures, multiple tubes, inlets and outlets are required. Therefore, providing air-pressure to the motor housing for this industrial robot is complex. In addition, the air inlet tube extends externally from the robot arm and this arrangement of the air tube might hinder the movement of the robot and the working range of the robot arm might be affected.

Accordingly, it would be advantageous to provide a joint and a modular robotic arm that help to improve shortcomings of the prior art and can be used in hazardous situations.

### SUMMARY

The present disclosure relates to a sealed joint module which is for use in association with an arm element of a robotic arm. The arm element may be a link, a seat, a payload interface or the like. The sealed joint module includes a module housing, a hollow joint assembly and a sealing assembly. The hollow joint assembly is operably attached to the module housing. The arm element is operably attachable to the hollow joint assembly. The sealing assembly is operably attached to the hollow joint assembly and to the module housing. The sealing assembly includes a dynamic sealing component between the arm element and the hollow joint assembly.

The hollow joint assembly may include a hollow servo motor, a hollow shaft and an external wall and wherein the arm element is operably attached to the servo motor of the hollow joint assembly.

The sealed joint module may further include a static sealing component between the external wall of the hollow joint assembly and the module housing.

The sealed joint module may be a two-degree-of-freedom sealed joint module wherein the joint is a first joint and the sealing assembly is a first sealing assembly and further including a second joint and a second sealing assembly. The first and second joints may be arranged at an angle to each other. The first and second joint may be orthogonal to each other.

The housing may include a housing cover releasably attached to the housing.

A static sealing component may be between the arm element and the servo motor.

The dynamic sealing component may include an outer resiliently deformable ring and a low-friction inner ring.

A modular robot arm includes at least two sealed joint modules and at least one link.

Each sealed joint module may be a two-degree-of-freedom joint module.

The link may be a generally hollow L-shaped link. The generally hollow L-shaped link may include a releasably attachable cover.

The link may be a generally elongate link. The elongate link may include a link body, a link enclosure and a link cover. The link enclosure may include a hollow tube and a pair of hat-shape sealing portions.

The robot arm may further include an air inlet.

One joint of the at least two sealed joint modules in the robot arm may be a two-degree-of-freedom shoulder joint, the other joint of the at least two sealed joint modules may be a two-degree-of-freedom elbow joint and further including a two-degree-of-freedom wrist joint and the at least one link is a shoulder link attached between the two-degree of freedom shoulder joint and the two-degree-of-freedom elbow joint and further including an elbow link attached between the two-degree-of-freedom elbow joint and the two-degree-of freedom wrist joint.

The robot arm may be further including a turret seat operably attached to the two-degree-of-freedom shoulder joint.

The turret seat of the robot arm may have an air inlet and the robot arm may include a payload interface operably attached to the wrist module whereby pressurized air may flow freely through the arm and is blocked by the payload interface such that a positive air pressure relative to the outside is maintained.

The arm element in at least one of the joint modules may be a link.

Further features will be described or will become apparent in the course of the following detailed description.

### BRIEF DESCRIPTION OF THE DRAWINGS

The embodiments will now be described by way of example only, with reference to the accompanying drawings, in which:

FIG. 1 is a side view of a robotic arm;

FIG. 2 is a perspective view of an elbow joint used in the arm shown in FIG. 1;

FIG. 3 is a cross sectional plan view of the sealing assembly of the elbow joint of FIG. 2;

FIG. 4 is a partially exploded perspective view of the elbow joint of FIG. 2;

FIG. 5 is a partially exploded perspective view similar to that shown in FIG. 4 but seen from a different angle;

FIG. 6 a front view of a static sealing component used in the sealing assembly of FIG. 3;

FIG. 7 is a partial perspective view of a dynamic sealing component used in the sealing assembly of FIG. 3;

FIG. 8 is perspective view of the housing cover of the joint module with static sealing components of FIGS. 4 and 5;

FIG. 9 is a side view of a robotic arm similar to that shown in FIG. 1 but showing additional sealing details;

FIG. 10 is an enlarged side view of the elbow link of the robotic arm of FIG. 9;

FIG. 11A is a perspective view of a shoulder link body of the robotic arms shown in FIGS. 1 and 9;

FIG. 11B is a perspective view of the shoulder link body of FIG. 11A but as seen from a different angle;

FIG. 12A is a perspective view of the shoulder link seal of the robotic arms shown in FIGS. 1 and 9;

FIG. 12B is a perspective view of the shoulder link seal of FIG. 12A but as seen from a different angle;

FIG. 13 is a blown apart perspective view of a shoulder link including the shoulder link body of FIGS. 11A and 11B and the shoulder link seal of FIGS. 12A and 12B; and

FIG. 14 is a side view of the robotic arm of FIGS. 1 and 9 and showing the air flow within the arm.

### DETAILED DESCRIPTION

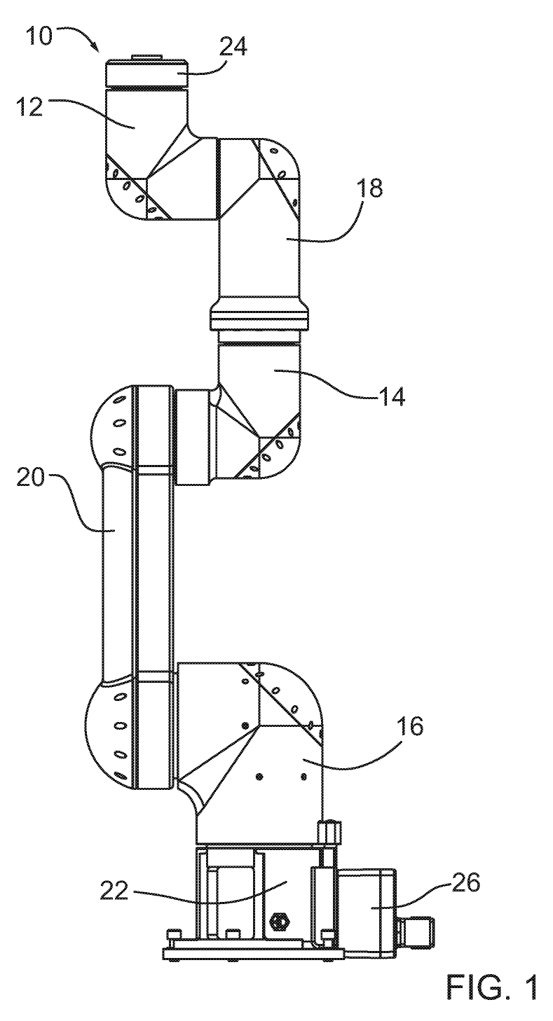

Referring to FIG. 1, an embodiment of a six degree-of-freedom robot arm is shown generally at 10. Robot arm 10 has three sets of modular two-degree-of-freedom joint modules namely a wrist module 12, an elbow module 14 and a shoulder module 16, one elbow link 18, one shoulder link 20 and one turret seat 22. A payload interface 24 is mounted on the wrist module 12. The payload interface 24 can be used to mount various tools, sensors and grippers for different applications.

An electronic box 26 is attached to the seat 22. The electronic box 26 may include: PCB boards for control and communication, electrical connectors, harness and power board for all the components of the robot arm.

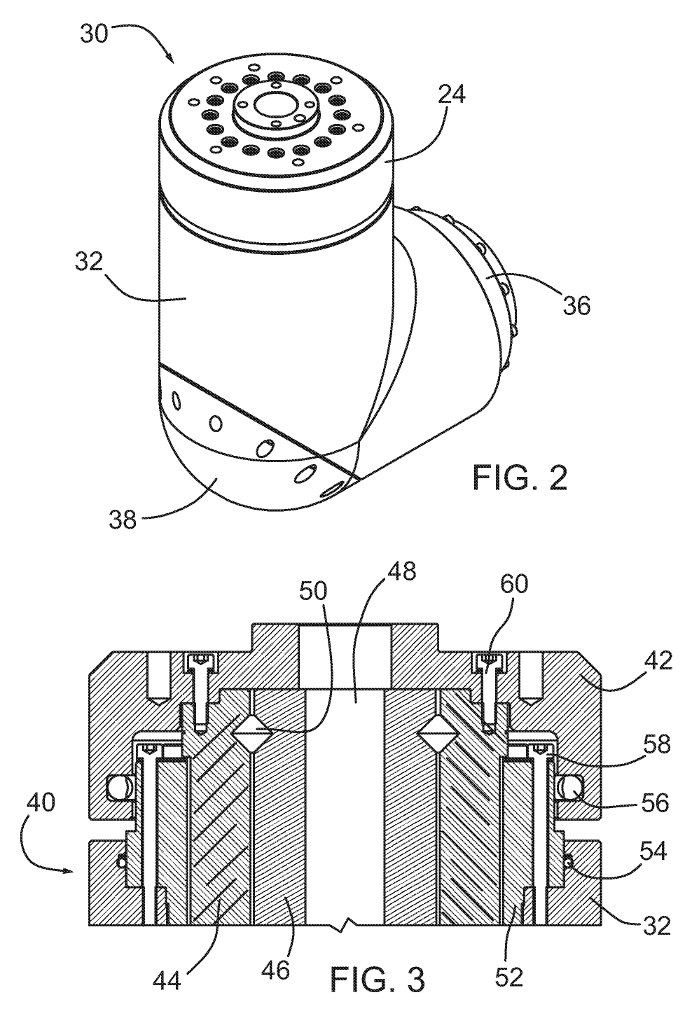

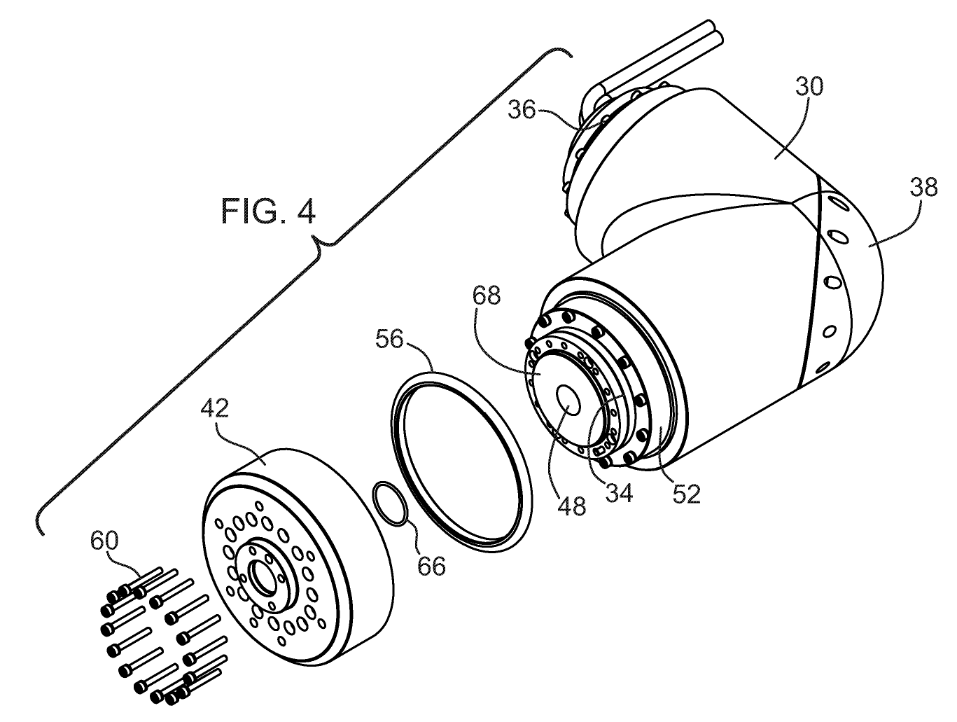

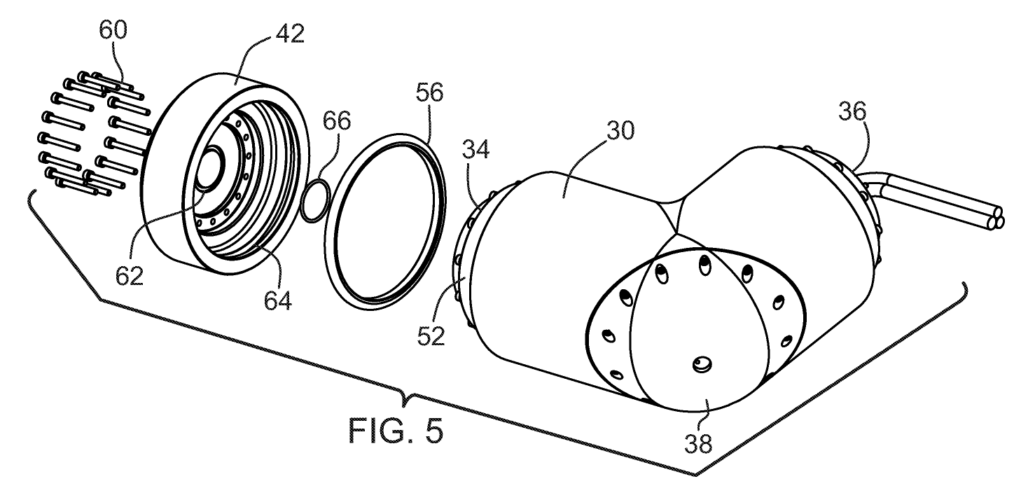

The two-degree-of-freedom joint modules 12, 14, 16 have similar characteristics and will be described generally with reference to a representative two-degree-of-freedom joint module shown in FIG. 2 at 30. The joint module 30 includes a module housing 32, two joints 34 (shown in FIGS. 4 and 5) and 36 and a housing cover 38. In the example herein, joints 34 and 36 are each hollow joint joint assemblies and they have identical structure. However, whilst they have identical structures for certain applications they may have different sizes. The hollow joint assemblies have a front and a back. The front is the output shaft of the joint assembly and the back is the opposite end of the joint assembly.

The joints 34 and 36 are positioned inside the module housing 32 and operably attached thereto. Joints 34 and 36 are arranged in series with their backs to each other or wherein the backs are in series with each other but at an angle to each other. The two joints 34 and 36 have rotational axes that are orthogonal to each other. However, it will be appreciated by those skilled in the art that the two joints may be at an angle to each other that is other than orthogonal. This may be desirable if the arm is being designed for a particular purpose and another angle would be more efficient.

The joint module 30 is a sealed joint module which includes a sealing assembly 40. FIG. 3 shows a sectional view of the sealing assembly 40 shown as part of a representative robot joint module 30. For ease of reference in the example herein the hollow joint assembly will be referred to as 34 and is by way of example only. However it will be appreciated that sealing assembly 40 will also form part of hollow rotary assembly 36. In robot joint module 30 there are a first joint 34 and a second joint 36 and a first sealing assembly 40 and a second sealing assembly (not visible). For ease of drawing, in FIGS. 2, 4 and 5 the sealing assembly 40 is not visible. However, in use a sealing assembly 40 will be attached to each of the hollow joint assemblies resulting in the two degree of freedom joint module 30 being generally symmetrical.

It will be appreciated by those skilled in the art that a typical joint is attached to a link, a turret seat or payload interface. The sealing assembly will be the same whether the joint is attached to any of these items. By way of example only the sealing assembly 40 shown in detail in FIGS. 3-5 is used in conjunction with the payload interface. This is by way of example only and the payload interface could be either a link or a turret seat or another type of connector. For ease of description, in FIGS. 3-5 the item that is connected to the hollow rotary joint 34 is referred to as a arm element 42. However those skilled in the art will appreciate that the arm element 42 may be a payload interface 24, a link 18, 20 or a turret seat 22. It will be appreciated that the configuration of the arm element 42 will be somewhat different but the specifics of the sealing assembly 40 will be the same. Arm element 42 and housing 32 rotate relative to each other. Housing 32 is the joint module housing described above. As discussed above, joints 34 and 36 are each hollow joint assemblies. Each hollow joint assembly includes a servo motor 44 and a hollow shaft 46. The hollow shaft 46 has a hollow section 48 which allows cables to pass therethrough and thus through the hollow joint assemblies. Each hollow joint assembly has an external wall 52. Bearing 50 is positioned between the motor 44 and the shaft 46.

A static sealing component 54 is between the external wall 52 of the actuator assembly and the housing 32. A dynamic sealing component 56 is between the arm element 42 and the external wall 52 of the actuator assembly.

Screws 58 attach the housing 32 to the external wall 52 of the actuator assembly. Screws 60 attach the arm element 42 to the servo motor 44 of the actuator assembly.

The link/adaptor or arm element 42 is fixed to the servo motor 44 by screws 60. Arm element 42, servo motor 44 and screws 60 rotate as one piece. The external wall 52 of actuator is fixed to the joint module housing 32 by the screw 58. External wall 52 of the actuator, housing 32 and screws 58 act as one piece. Link/payload interface or arm element 42 rotates relative to hollow shaft 46 and hollow section 48 through the bearing 50. External wall 52, screws 58 and housing 32 are relatively static relative to the hollow shaft 46 and hollow section 48. Therefore, arm element 42, servo motors 44 and screws 60 rotate relative to external wall 52, screws 58 and housing 32.

Static component is mounted between 2 non-moving parts. For instance, the external wall 52 of the actuator and the housing 32 are two non-moving parts. There is no relative motion between them. Therefore, a static sealing component 54 is in between these two parts. In contrast dynamic sealing component 56 is mounted between a moving part and a non-moving part. For instance, the arm element 42 is a moving part and the external all of the actuator 52 is a non-moving part since 42 is rotating relative to 52. Therefore, a dynamic sealing component 56 is in between of these two parts.

It will be appreciated that under normal manufacturing conditions there will be gaps between the two relatively static parts. Thus, the seal assembly 40 described herein in part allows the robot arm 10 to work in hazardous environments such as painting stations, sanding stations, polishing stations and grinding stations in manufacturing.

FIGS. 4 and 5 show the exploded view of the two-degree-of-freedom robot joints with sealing components. The link/payload interface or arm element 42 includes groves 62, 64 which are coaxial with the arm element static sealing 66, dynamic sealing 56, and the hollow joint assembly 34. The static sealing component 66 engages the grove 62 of the arm element 42, which contacts the surface 68 of the hollow joint assembly 34. Once the arm element static sealing component 66 is mounted on the grove 62, and the arm element 42 is fully in contact with to surface 68, then the sealing components contacting the arm create a sealed environment where ideally there is no-leakage inside the arm.

It will be appreciated by those skilled in the art that the static sealing components 54 and 66 described above are generally the same. However, static sealing component 66 is used between two flat surfaces. For instance, the static sealing component 66 (in FIGS. 4 and 5) is in between the surface 68 of the hollow joint assembly and the grove 62 of the arm element 42. In contrast, static sealing component 54 is used between two circular surfaces. For instance, the static sealing component 54 (in FIG. 3) is in between the external wall 52 of the actuator, which has a circular surface and the housing 32, which has a circular surface. The configuration of these two static sealing components are the same: both of them are an O-shape ring structure.

The dynamic sealing component 56 is mounted in a groove 64 on the arm element 42. Groove 64 is generally circular grove and similarly the dynamic sealing component 56 is generally circular. The dynamic sealing component 56 contacts the wall 52 of the hollow joint assembly. In general, the dynamic sealing component 56 is mounted in between the external wall 52 of the hollow joint assembly—the non-moving part and the arm element 42—the moving part.

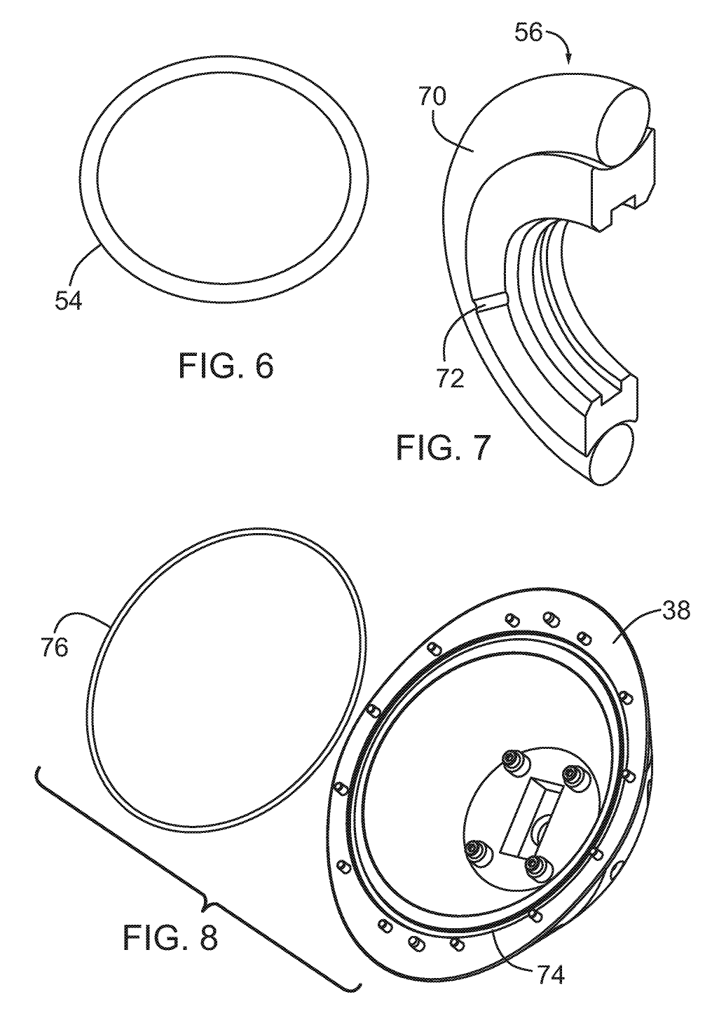

FIG. 6 shows an example of a static sealing component 54. The static sealing component 54 is a rubber ring that is mounted at the interface between two relatively static parts. FIG. 7 shows an example of a dynamic sealing component 56. Dynamic sealing component 56 includes two parts: an outer resiliently deformable ring 70 for sealing and a wear-resistant, low-friction slipping plastic inner ‘O-ring’ 72. The outer resiliently deformable ring 70 may be a rubber ring. The resiliently deformable ring 70 completely covers the outside edge of the sealing ring or low-friction plastic inner O-ring 72 to form one piece or the dynamic seal component 56. The dynamic sealing component 56 is used between two mechanical parts which are moveable relative to each other. There are rotational movements between the mechanical parts so the sealing components are rotatable in between the moving parts. The plastic sealing ring 72 is directly installed and contacted in between the rotatable mechanical components, and the ring can slide around while the two parts are rotating. The plastic sealing ring 72 protects the deformable ring 70 from abrasion and wearing against the mechanical parts so the life time of entire sealing device can last longer.

It will be appreciated by those skilled in the art that the static sealing component 54 shown in FIG. 6 and the dynamic sealing component shown in FIG. 7 are by way of example only.

FIG. 8 shows sealing method for housing cover 38 used on the joint module 30 of robot arm 10. The housing cover 38 includes a groove 74 for accommodating a cover static sealing component 76. Cover static sealing component 76 is similar to static sealing component 54. As shown herein cover static sealing component 76 may be a rubber ‘O-ring’. The housing cover 38 is releasably attachable to the housing 32.

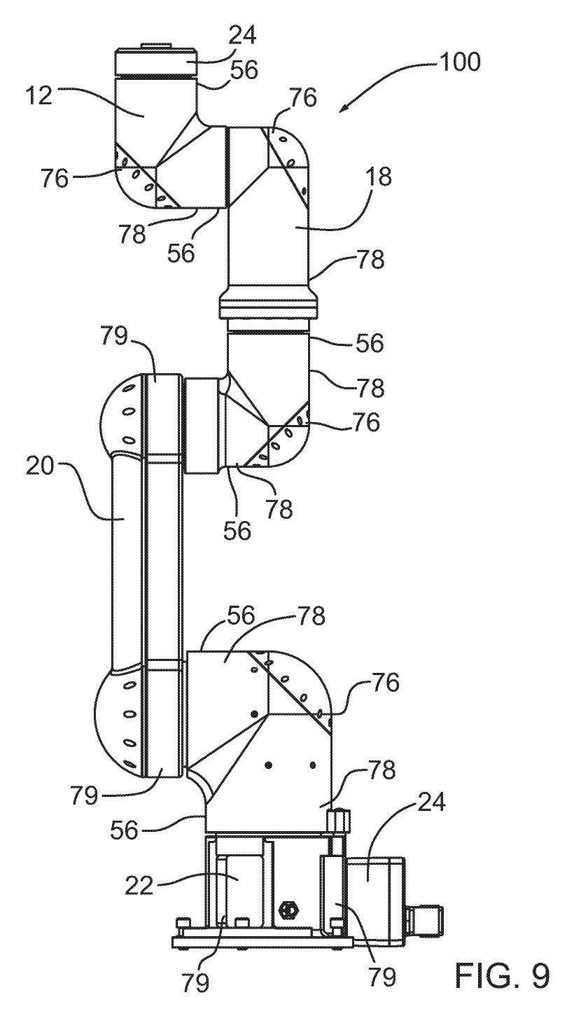

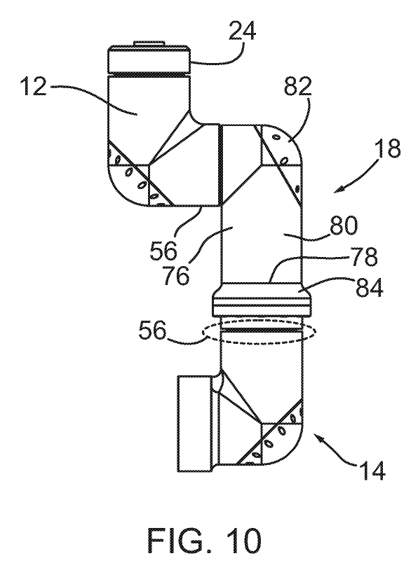

Referring to FIG. 9 the arm 100 shown herein is similar to that shown in FIG. 1 but the sealing components are specifically identified and discussed. It will be appreciated by those skilled in the art that arm 100 is shown by way of example only and that other configurations may also be used. The other configurations would also use a combination of dynamic and static sealing component as discussed herein. Arm 100 includes twenty-two (22) sealing components, specifically six (6) dynamic sealing components 56 and sixteen (16) static sealing components.

A plurality of dynamic sealing components 56 are located between relative rotating parts. Two dynamic sealing components are located at each end of each two-degree-of-freedom joint modules, namely the wrist module 12, the elbow module 14 and the shoulder module 16. At the wrist, the wrist module 12 is rotatable relative to the wrist link 18; the elbow link 14 is rotatable relative to the wrist link 18 and the shoulder link 20; and at the turret seat 22 the shoulder module 16 is rotatable relative to the turret seat 22 and adaptor interface or electronic box 26 and the shoulder link 20.

The static sealing components are mounted in the seams or interface between relative static parts. One type of the static sealing component 76 is mounted on the cover 38 of the joint module as shown in FIG. 8. These static sealing components 76 are shown on FIG. 9 in association with a number of joint modules, specifically wrist module 12, elbow module 14, shoulder module 16 and wrist link 18. A plurality of another type of static sealing components 78 are mounted on the joint, links and turret seats. Static sealing component 76, 78 and 79 are all similar and are all O-shaped ring structures. Static sealing component 76 is similar to static sealing component 66 described above. Static sealing component 76 is used between two flat surfaces. Similarly static sealing component 79 is used between two flat surfaces. Static sealing component 78 is similar to static sealing component 54. Static sealing components 78 are between circular surfaces.

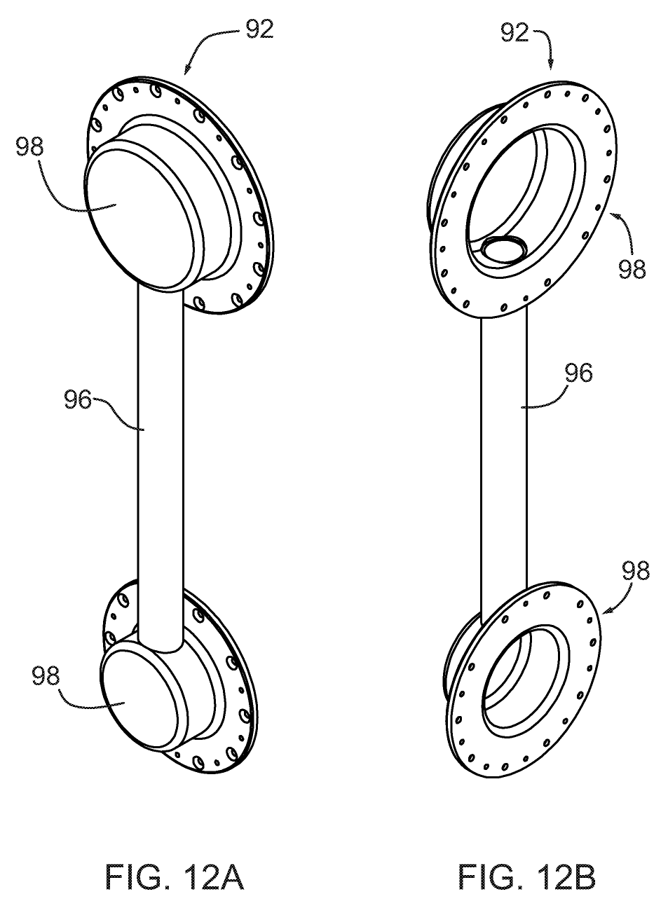

As shown herein there are a static sealing components 78 used in the interface between the covers and the housings of the wrist module 12, elbow module 14, shoulder module 16 and elbow link 18. Static sealing components 79 are used at the interface of the payload interface 24, the turret seat 22, the electronic box 26 and either end of shoulder link 20. Static sealing components 78 are used in the wrist module 12, elbow module 14, shoulder module 16 and elbow link 18. It will be appreciated by those skilled in the art that while the general location of the sealing components is shown on FIG. 9, the sealing component would not be visible from outside, rather they would be internal. By way of illustration a sealed link is shown in FIG. 12. The link shown herein is a generally L-shaped link and in the embodiment shown in FIGS. 1 and 9 is an elbow link. The elbow link module 18 shown herein is by way of example only and it will be appreciated by those skilled in the art that the other links may be similarly sealed. The elbow link 18 is connected to the wrist module 12 and elbow module 14. The elbow link module 18 includes an elbow link body 80 and a releasably attachable elbow link cover 82. The elbow link body 80 is generally L-shaped and the cover 82 is at the corner. The elbow link body 80 is generally tubular and the cover provides access to the inside of the body 80. The body 80 includes a connection interface 84 to facilitate the connection to elbow module 14. The connection interface 84 is a mechanical device used to connect the elbow joint (14) and elbow link (18).

The cover includes a static sealing component 76 positioned similar to that shown in FIG. 8. The link cover 82 is sealed to the body 80. The static sealing component 78 is in between the connection interface 84 and the elbow link body 80. The sealing component is in between circular surface.

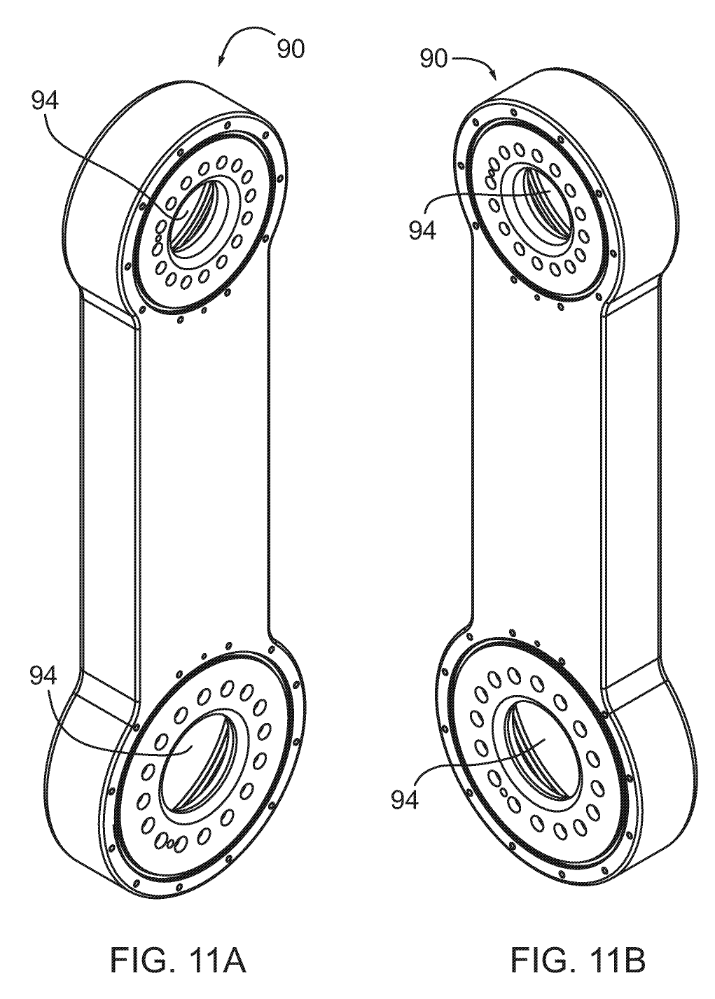

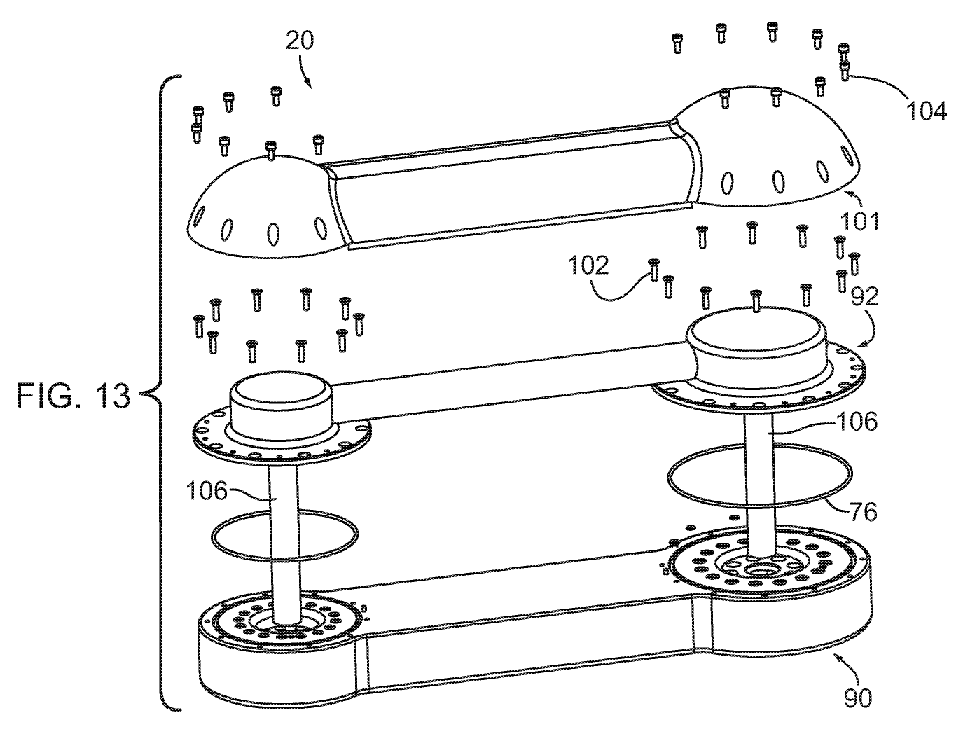

By way of example a generally elongate link is shown in FIGS. 11,12 and 13. The elongate link shown herein is used in the arm shown in FIGS. 1 and 9 is a shoulder link. The component part of the shoulder link 20 are shown in FIGS. 11A, 11B and 12A, 12B and a blown apart view of the shoulder link is shown in FIG. 13. The shoulder link 20 includes a shoulder link body 90 shown in FIGS. 11A and 11B and a shoulder link sealing enclosure 92 shown in FIGS. 12A and 12B. The shoulder link body 90 is generally elongate with a pair of connection portions 94 at each end thereof. The shoulder link body 90 has an outside best seen in FIG. 11A and an inside best seen in FIG. 11B. The shoulder link sealing enclosure 92 includes a hollow tube 96 and a pair of hat-shape sealing portions 98 at either end of the hollow tube 96. The hollow tube 96 is connected to the pair of hat-shape portions 98 such that cables (not shown) can pass therethrough in a sealed environment.

FIG. 13 is a blown apart view of shoulder link 20. Shoulder link 20 includes a shoulder link body 90, a shoulder link sealing enclosure 92 and a shoulder link cover 101. A pair of static sealing components 76 is positioned between the shoulder link body 90 and the shoulder link enclosure 92. A plurality of screws 102 connects the shoulder link enclosure 92 to the shoulder link body 90 and a plurality of screws 104 connects the shoulder link cover 101 to the shoulder link body 90. Cable bundle 106 passes through the shoulder link sealing enclosure 92.

By way of example only the shoulder link body 90 is machined of solid metal thus cables cannot go through the link body from inside. Therefore, the link sealing enclosure 92 as described above is designed to cover the cables.

The arm 100 shown herein is made of a plurality of sealed joints and links and thus the entire robot arm is completed sealed from exterior and internal electronics components are isolated from outside. However, to better isolate the arm interior from exterior, the robot arm interior may be maintained at a positive air pressure relative to the outside.

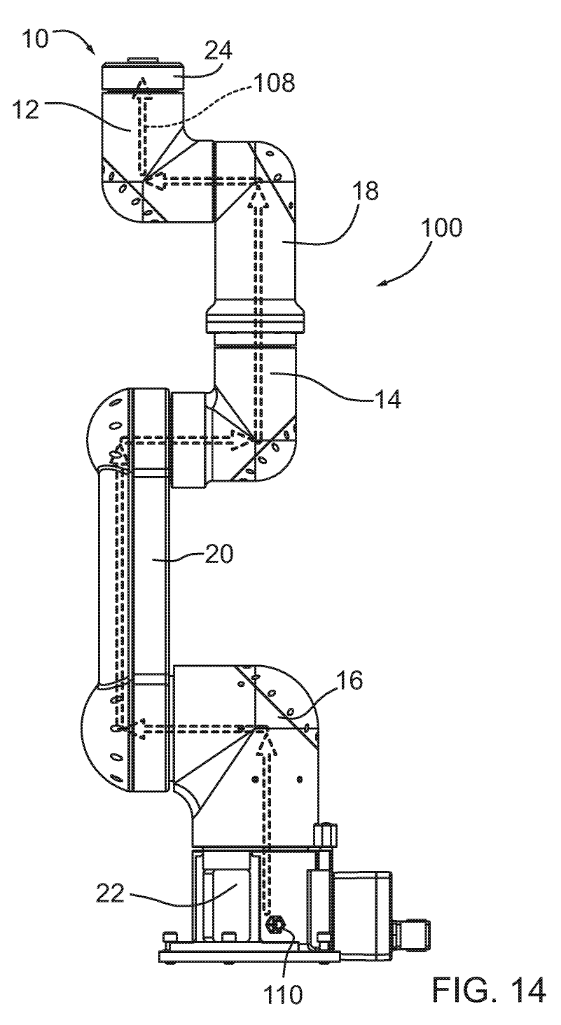

For certain uses it will be desirable to provide an arm that has a positive internal air pressure. The purpose is to ideally prevent dust or other particles from going into the arm. The arm is a sealed closed structure, full of pressurized air. By way of example FIG. 14 shows the air passage 108 within the arm 100. The air is injected into the arm from the air inlet 110 at the turret seat 22, and air passes through the turret-shoulder module 16, shoulder link 20, elbow module 14, elbow link 18 and wrist module 12. The air is finally blocked by the payload interface 24 of the arm. Essentially the arm is a sealed closed structure since all the joints and links have sealed components. There is pressurized air/gas passing through from the bottom to the top of the arm so that ideally dust is prevented from getting into the arm.

Therefore, the air cannot leak out from the payload interface 24 end. The entire arm interior is sealed and has a positive air pressure. As can be seen there is a continuous air passage 108 through all of the components in the arm 100. Thus, only one air inlet 110 is required.

It will be appreciated by those skilled in the art that the modular industrial arm 100 shown herein uses hollow joint assemblies as described above and shown in FIGS. 2 to 5. Since the arm uses hollow joint assemblies, most of mechanical parts are seamlessly integrated as one assembly. Therefore, there is much less gaps/seams between parts and only simple sealing protections are required. The sealing component of arm 100 consists of several ‘O-ring’ sealing components at certain parts of joint module and links of the arm.

Further, it will be appreciated by those skilled in the art that the modular robotic arm shown herein is reconfigurable. Thus while the arm shown herein includes three two-degree-of-freedom joints and two links, alternate configurations could be assembled. The arm could be made of at least two joints and at least one link. Alternatively it could be made of more than 3 joints and 2 links. The arm can be reconfigured for a specific purpose whilst still maintaining the properties of being usable in hazardous environments.

Generally speaking, the systems described herein are directed to a sealed robotic joint and arms using same. Various embodiments and aspects of the disclosure are described in the detailed description. The description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein the “operably connected” or “operably attached” means that the two elements are connected or attached either directly or indirectly. Accordingly the items need not be directly connected or attached but may have other items connected or attached therebetween.

What is claimed is:

1. A sealed joint module for use in association with an arm element of a robotic arm being a link, a seat, a payload interface or the like, the sealed joint module comprising:
a module housing;
a hollow joint assembly being operably attached to the module housing, whereby the arm element is operably attachable to the hollow joint assembly;
a sealing assembly being operably attached to the hollow joint assembly and to the module housing, the sealing assembly including:
a dynamic sealing component between the arm element and the hollow joint assembly.

2. The sealed joint module of claim 1 wherein the hollow joint assembly includes a hollow servo motor, a hollow shaft and an external wall and wherein the arm element is operably attached to the servo motor of the hollow joint assembly.

3. The sealed joint module of claim 2 wherein the sealing assembly further includes a static sealing component between the external wall of the hollow joint assembly and the module housing.

4. The sealed joint module of claim 3 wherein the joint is a first joint and the sealing assembly is a first sealing assembly and the sealed joint module further includes a second joint and a second sealing assembly to provide a two-degree-of freedom sealed joint module.

5. The sealed joint module of claim 4 wherein the housing further includes a housing cover releasably attached to the module housing.

6. The sealed joint module of claim 4 wherein the first and second joint are arranged at an angle to each other.

7. The sealed joint module of claim 4 wherein the first and second joint are orthogonal to each other.

8. The sealed joint module of claim 2 further including a static sealing component between the arm element and the servo motor.

9. The sealed joint module of claim 1 wherein the dynamic sealing component includes an outer resiliently deformable ring and a low-friction inner ring.

10. A modular robot arm comprising:
at least one arm element; and
at least two sealed joint modules wherein each joint module includes:
a module housing;
a hollow joint assembly being operably attached to the module housing whereby the arm element is operably attached to the hollow joint assembly; and
a sealing assembly operably attached to the joint and to the module housing, the sealing assembly including:
a dynamic sealing component between the arm element and the hollow joint assembly.

11. The robot arm of claim 10 wherein each sealed joint module is a two-degree-of-freedom joint module.

12. The robot arm of claim 10 wherein the arm element is a generally hollow L-shaped link.

13. The robot arm of claim 12 wherein the generally hollow L-shaped link includes a releasably attachable cover.

14. The robot arm of claim 10 wherein the arm element is a generally elongate link.

15. The robot arm of claim 14 wherein the elongate link includes a link body, a link enclosure and a link cover.

16. The robot arm of claim 15 wherein the link enclosure includes a hollow tube and a pair of hat-shape sealing portions.

17. The robot arm of claim 10 further including an air inlet.

18. The robot arm of claim 10 wherein one joint of the at least two sealed joint modules is a two-degree-of-freedom shoulder joint, the other joint of the at least two sealed joint modules is a two-degree-of-freedom elbow joint and further including a two-degree-of-freedom wrist joint and the at least one arm element is a shoulder link attached between the two-degree of freedom shoulder joint and the two-degree-of-freedom elbow joint and further including an elbow link attached between the two-degree-of-freedom elbow joint and the two-degree-of freedom wrist joint.

19. The robot arm of claim 18 further including a turret seat operably attached to the two-degree-of-freedom shoulder joint.

20. The robot arm of claim 19 wherein the turret seat has an air inlet and further including a payload interface operably attached to the wrist module whereby pressurized air flows freely through the arm and is blocked by the payload interface such that a positive air pressure relative to the outside is maintained.
